(19) United States
(12) Patent Application Publication
(10) Pub. No.: US 2019/0362639 A1
(43) Pub. Date: Nov. 28, 2019

(54) SYSTEMS AND METHODS FOR CLOUD-BASED DISTRIBUTION OF ROUTE SPECIFIC NAVIGATION DATA BASED ON REAL-TIME DATA

(71) Applicant: Honeywell International Inc., Morris Plains, NJ (US)

(72) Inventors: Umesh HOSAMANI, Bangalore (IN); Raghu SHAMASUNDAR, Bangalore (IN)

(21) Appl. No.: 15/989,409

(22) Filed: May 25, 2018

(51) Int. Cl. G08G 5/00; G01C 21/34; H04W 4/40

(52) U.S. Cl. CPC G08G 5/0047; G08G 5/0039; H04W 4/40; G01C 21/3492

(57) ABSTRACT

Systems and methods are disclosed for improving navigation database efficiency by using the cloud to distribute route specific navigation data based on real-time navigation plan data. Methods comprise receiving a request for adaptive navigation dataset at cloud services from a plan loader; querying a real-time data and vehicle history servers for real-time and historical information; obtaining the queried information from the real-time data and vehicle history servers; generating a navigation plan and adaptive navigation dataset; and transmitting the navigation plan and adaptive navigation dataset to the plan loader and/or a navigation database.

### TECHNICAL FIELD

Various embodiments of the present disclosure relate generally to the field of navigation and, more particularly, to a system and method for improving the efficiency of a navigation management system by providing adaptive navigation data.

### BACKGROUND

All modern aircraft have Flight Management Systems (“FMS”). The FMS and its associated databases are an essential part of modern avionics, and one such database is a navigation database (“NDB”). The NDB contains all the information required for building a flight plan and processing the flight plan once airborne. Three important parameters regulate content selection for NDBs: waypoint count, terminal data and total FMS capacity. The NDB flight plan data is updated via a 28 day AIRAC cycle. An NDB's capacity (memory size) depends largely on both the hardware and software needs of a particular FMS, as well as the large amounts of flight plan related data that is typically transmitted to the FMS NBD. As such, the NDB's capacity and its ability to support AIRAC cycle data updates (which has been increasing in size at an annual rate of 3-8%), has always been a point of contention for the aviation industry. In response to the NBD's capacity issue, the aviation industry has often sought to consistently increase the NBD's capacity. However, significant data increases are expected to continue in the foreseeable future. Therefore, the need to increase the NBD in response to growing data size is anticipated to be an ongoing challenge for the aviation industry.

Another challenge the aviation industry is facing is the delivery and processing of Notices to Airmen (“NOTAM”). Traditionally, pilots receive multiple NOTAMs in paper or electronic form that must be extracted from a larger pool of data, deciphered, and then manually evaluated for relevant information specific to a flight plan. Such a procedure is inefficient and may result in either significant down-time or a pilot's failure to notice critical notifications. Additionally, since NDB data is updated on a 28 day AIRAC cycle, most urgent NOTAMs are not made available in real-time via the NDB, thus increasing pilot work load and safety concerns.

The present disclosure is directed to overcoming one or more of these above-referenced challenges.

### SUMMARY OF THE DISCLOSURE

According to certain aspects of the disclosure, systems and methods are disclosed for improving navigation database efficiency by using cloud infrastructure to distribute route specific navigation data based on real-time navigation plan data.

In one embodiment, a computer-implemented method is disclosed for providing adaptive navigation datasets to plan loaders and vehicle management systems. The method includes: receiving, at a remote server, a request to receive an adaptive navigation dataset associated with a navigation plan; obtaining, by the remote server, real-time and historical information based on the navigation plan; generating, by the remote server, an adaptive navigation dataset based on the navigation plan, and the obtained real-time and historical information; and transmitting the generated adaptive navigation dataset from the remote server to the remote plan loader and/or the navigation database located on the vehicle.

In accordance with another embodiment, a system is disclosed for providing adaptive navigation dataset to plan loaders and vehicle management systems. The system comprises: a memory having processor-readable instructions stored therein; and a processor configured to access the memory and execute the processor-readable instructions, which when executed by the processor configures the processor to perform a plurality of functions, including functions to: receive, at a remote server, a request to receive an adaptive navigation dataset associated with a navigation plan; obtain, by the remote server, real-time and historical information based on the navigation plan; generate, by the remote server, an adaptive navigation dataset based on the navigation plan, and the obtained real-time and historical information; and transmit the generated adaptive navigation dataset from the remote server to the remote plan loader and/or the navigation database located on the vehicle.

In accordance with another embodiment, a non-transitory computer-readable medium is disclosed for providing adaptive navigation dataset to plan loaders and vehicle management systems. A non-transitory, tangible computer readable medium having instructions stored thereon that, in response to instructions by a computer-based system, cause the computer-based system to perform operations comprising: receive, at a remote server, a request to receive an adaptive navigation dataset associated with a navigation plan; obtain, by the remote server, real-time and historical information based on the navigation plan; generate, by the remote server, an adaptive navigation dataset based on the navigation plan, and the obtained real-time and historical information; and transmit the generated adaptive navigation dataset from the remote server to the remote plan loader and/or the navigation database located on the vehicle.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts a block diagram of an exemplary environment for providing navigation plans and adaptive navigation data to vehicle management systems via a plan loader.

FIG. 2 depicts a block diagram of an exemplary environment for providing navigation plans and adaptive navigation data to a flight management system via a plan loader.

FIG. 3 depicts a block diagram of an exemplary environment for providing navigation plans and adaptive navigation data to a flight management system directly from cloud services.

FIG. 4 depicts a flow diagram of an exemplary method of generating an adaptive analytics dataset for transmission to a vehicle management system.

FIG. 5 depicts a flow diagram of an exemplary method for processing a request for an adaptive navigation dataset and navigation plan based on real-time and flight history information.

### DETAILED DESCRIPTION OF EMBODIMENTS

While principles of the present disclosure are described herein with reference to illustrative embodiments for particular applications, it should be understood that the disclosure is not limited thereto. Those having ordinary skill in the art and access to the teachings provided herein, will recognize that the features illustrated or described with respect to one embodiment, may be combined with the features of another embodiment. Therefore, additional modifications, applications, embodiments, and substitution of equivalents, all fall within the scope of the embodiments described herein. Accordingly, the invention is not to be considered as limited by the foregoing description.

Various non-limiting embodiments of the present disclosure will now be described to provide an overall understanding of the principles of the structure, function, and use of methods and systems for providing adaptive navigation dataset to plan loaders and vehicle management systems.

As described above, there is a need in the field of vehicle navigation for systems and methods that improve the efficiency of navigation databases and vehicle management systems by providing route focused navigation plans and adaptive navigation datasets. A navigation plan can be combined with real-time information and vehicle history information to generate an adaptive navigation dataset, which can be used by the vehicle management system to allocate system resources to matters pertinent to an anticipated route that will be traversed. Moreover, as described above, in some cases, vehicle operators and vehicle management systems are only updated periodically, e.g., every 28 days, with critical information route information. Thus, the embodiments of the present disclosure are directed to generating route specific navigation plans and adaptive navigation datasets based on real-time information and historical information.

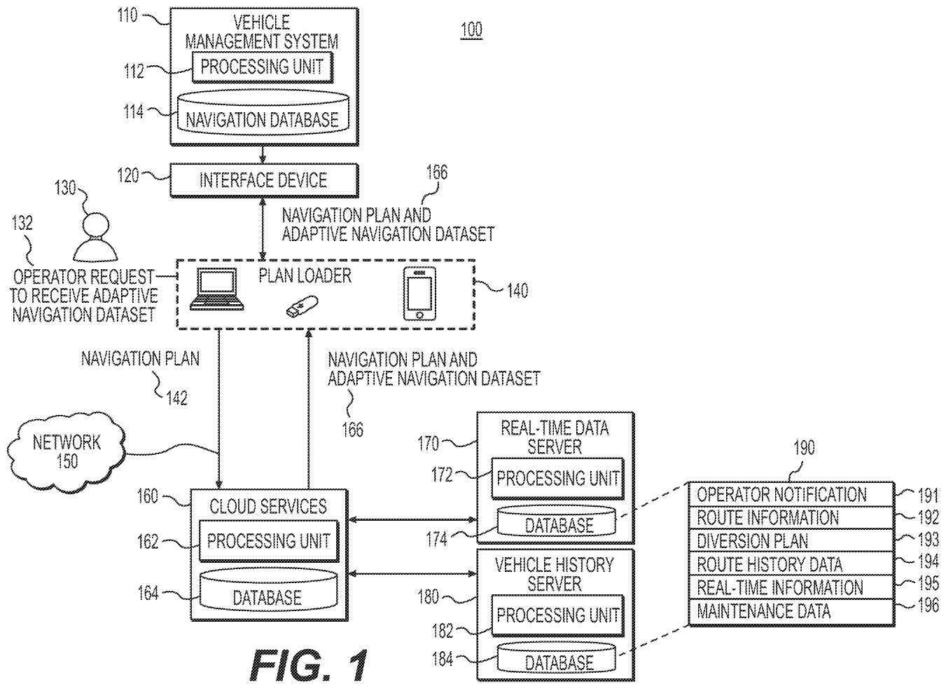

FIG. 1 depicts a block diagram of an example vehicle navigation environment 100 in which a vehicle management system 110 and/or an operator 130 requests 132 to receive an adaptive navigation dataset (step 132). As shown in FIG. 1, the vehicle navigation environment generally comprises the vehicle management system 110 in communication with a plan loader 140 via an interface device 120. FIG. 1 also shows the plan loader 140 in communication with cloud services 160 via a network 150, such as the Internet or any satellite communications network. FIG. 1 also shows cloud services 160 in communication with a real-time data server 170 and vehicle history server 180. Thus, at a high level, vehicle management system 110 is provided in communication with real-time data server 170 and vehicle history server 180 via interface device 120, plan loader 140, and cloud services 160. In one embodiment, real-time data server 170 and vehicle history server 180 are components of cloud services 160. Moreover, interface device 120 and plan loader 140 should be understood as optional, as vehicle management system 110 may be provided in communication with cloud services 160 via any desired method.

In this embodiment shown in FIG. 1, an operator 130 may use plan loader 140 to request 132 to receive an adaptive navigation dataset. As part of the request to receive an adaptive navigation dataset 132 the operator 130 may use plan loader 140 to transmit a navigation plan 142 to cloud services 160 via network 150. Upon receipt of the request 132 to receive an adaptive navigation dataset, the cloud services 160 may obtain real-time information from real-time data server 170 and vehicle history information from vehicle history server 180 in order to generate and then transmit a navigation plan and an adaptive navigation dataset 166 back to the plan loader 140. Once the navigation plan and adaptive navigation dataset 166 are received at the plan loader 140, the navigation plan and adaptive navigation dataset 166 may be manually or automatically uploaded to the vehicle management system 110 and stored.

The vehicle management system 110 may have various computing components to manipulate the received navigation plan and adaptive navigation dataset 166, such as, a processing unit (e.g. a processor and modules) 112 and a navigation database 114. The vehicle management system 110 may be a computer, a server, a mobile device (e.g. PDA, mobile phone, or a tablet), etc. The vehicle management system 110 may receive and transmit data through an interface device 120. The interface device 120 may have ports to receive and transmit data, the ability to write on storage media and/or the ability to communicate with systems and devices wirelessly. The plan loader 140 may be any device capable of sending and receiving data, for example, a computer or a mobile device (e.g. PDA, mobile phone, or a tablet), etc. The plan loader 140 may also be a storage medium, for example, removable memory based media (USB memory devices/readers, removable hard drives, flash drives, thumb drives, jump drives, key drives, readable/rewritable DVDs, readable/rewritable CDs, and floppy disks) or memory card (SD, CompactFlash, miniSD, microSD, and xD cards), etc. Cloud services 160 may comprise one or more servers, computers or mobile devices and may include computing components, such as a processing unit (e.g. a processor and modules) 162 and a database 164. Similarly, the real-time data server 170 may include computing components, such as a processing unit (e.g. a processor and modules) 172 and a database 174. Additionally, the vehicle history server may include computing components, such as a processing unit (e.g. a processor and modules) 182 and a database 184. Both the real-time data server database 174 and the vehicle history server database 184 may store data including, but not limited to, operator notifications 191 (e.g. airline procedures, terminal information, etc.), route information 192 (e.g. runway information, route clearances, waypoints, and airport information), diversion plans 193, route history data 194, real-time information 195, and/or maintenance data 196, among other data. Further, the data and data transmissions may be encrypted. The network 150 may be the internet, VPN, LAN, WAN, Airborne Wireless Network (AWN), a vehicle-to-vehicle network, 3G/4G/5G wireless signal, WiMax, CDMA, LTE, satellite uplink or any combination thereof.

Notably, while the navigation database 114 can be updated on the periodic or even irregular cycle, it should be understood that the navigation plan and adaptive navigation dataset 166 could be uploaded upon any operator request 132 to receive adaptive navigation dataset 166 or it could be transmitted to the plan loader 140 and vehicle management system 110 dynamically as needed. Additionally, the cloud services processing unit 162, real-time data server processing unit 172, and the vehicle history server processing unit 182 could include information selection modules, such that only relevant information is included in the navigation plan and adaptive navigation dataset 166 during a dynamic transmission. The information selection modules may select information according to various criteria, triggers, machine learning algorithms or any combination thereof. For example, an operator request 132 to receive adaptive navigation dataset, may include information unique to the vehicle being operated (e.g. a unique vehicle identification number), information about the vehicle management system 110 (e.g. NDB capacity, NDB memory usage information, information regarding what type of information is currently stored in the NDB), information regarding the vehicle operator 130 (e.g. operator unique identification number, operator preferences, operator health information, etc.), information regarding the passengers or cargo being carried in the vehicle, and a navigation plan, such that cloud services 160 can cross analyze this information with the information received from the real-time data server 170 and vehicle history server 180 to select a navigation plan and adaptive navigation dataset 166 that will align with the preferences of the operator 130 and meet the capacity constraints of the navigation database 114. Further, cloud services 160 may transmit the navigation plan and adaptive navigation dataset 166 at certain time intervals as a consideration of the network 150 bandwidth or vehicle management system 110 resources.

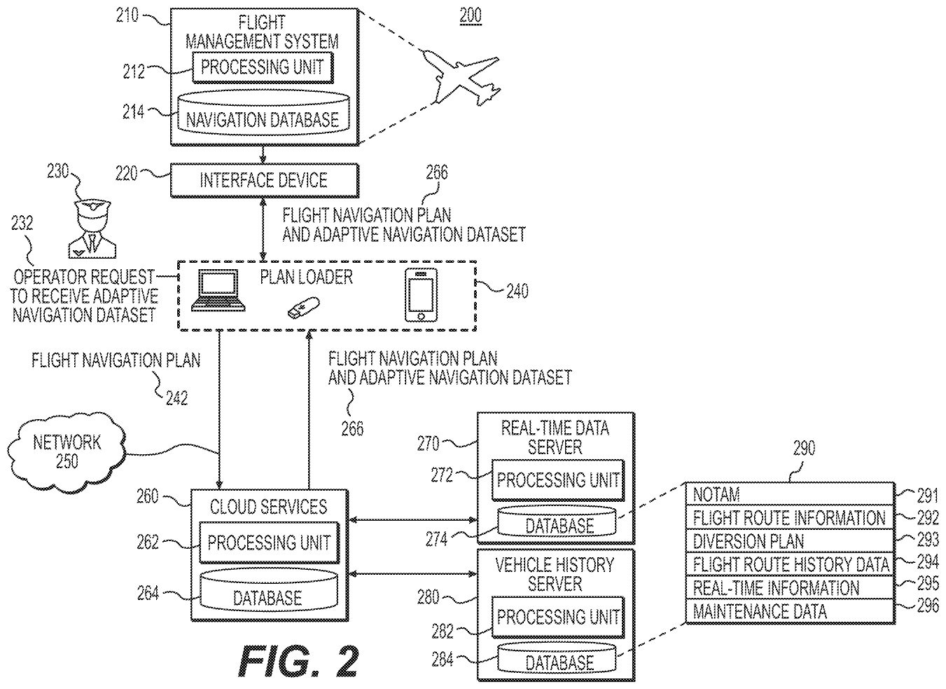

As illustrated in FIG. 2, the above-mentioned devices and systems can be directed to an aircraft management environment 200. FIG. 2 depicts a block diagram of an example flight management system 210, wherein an operator 230 (e.g., a pilot) requests 232 to receive an adaptive navigation dataset. In this embodiment, as part of the request 232 to receive an adaptive navigation dataset, the operator 230 (e.g. a pilot, flight crew or maintenance crew) uses the plan loader 240 to transmit a navigation plan 242 to cloud services via a network 250. Upon receipt of the request 232 to receive an adaptive navigation dataset, the cloud services 260 may obtain real-time information from a real-time data server 270 and vehicle history information from a vehicle history server 280, in order to generate and then transmit a navigation plan and an adaptive navigation dataset 266 back to the plan loader 240. Once the navigation plan and adaptive navigation dataset 266 are received at the plan loader 240, the navigation plan and adaptive navigation dataset 266 may be manually or automatically uploaded to the flight management system 210.

The flight management system 210 will have various computing components to manipulate the received navigation plan and adaptive navigation dataset 266, such as a processing unit 212 (e.g. a processor and modules) and a navigation database 214. The flight management system may be a computer, a server, a mobile device (e.g. PDA, mobile phone, or a tablet), etc. The flight management system 210 may receive and transmit data through an interface device 220. The interface device 220 may have ports to receive and transmit data, the ability to write on storage media, and/or the ability to communicate with systems and devices wirelessly. The plan loader 240 may be any device capable of sending and receiving data, for example, a computer or a mobile device (e.g. PDA, mobile phone, or a tablet), etc. The plan loader 240 may also be a storage medium, for example, removable memory based media (USB memory devices/readers, removable hard drives, flash drives, thumb drives, jump drives, key drives, readable/rewritable DVDs, readable/rewritable CDs, and floppy disks) or memory card (SD, CompactFlash, miniSD, microSD, and xD cards), etc.

Cloud services 260 may be a server, a computer or mobile device and it may include computing components, such as a processing unit 262 (e.g. a processor and modules) and a database 264. Similarly, the real-time data server 270 may include computing components, such as a processing unit 272 (e.g. a processor and modules) and a database 274. Additionally, the vehicle history server may include computing components, such as a processing unit 282 (e.g. a processor and modules) and a database 284. Both the real-time data server database 274 and the vehicle history server database 284 may store data including, but not limited to, operator notifications 291 (e.g. airline procedures, terminal information, etc.), route information 292 (e.g. runway information, route clearances, waypoints, and airport information), diversion plans 293, flight route history data 294, real-time information 295, and maintenance data 296. The network 250 may be the Internet, VPN, LAN, WAN, Airborne Wireless Network (AWN), a vehicle-to-vehicle network, 3G/4G/5G wireless signal, WiMax, CDMA, LTE, VHF/HF/Datalink satellite uplink or any combination thereof.

Notably, while the navigation database 214 can be updated on the AIRAC 28 day cycle, it should be understood that the navigation plan and adaptive navigation dataset 266 could be uploaded upon any operator request 232 to receive an adaptive navigation dataset or it could be transmitted to the plan loader 240 and vehicle management system 210 dynamically as needed. Additionally, the cloud services processing unit 262, real-time data server processing unit 272, and the vehicle history server processing unit 282 could include information selection modules, such that only relevant information is included in the navigation plan and adaptive navigation dataset 166 during an dynamic transmission. The information selection modules may select information according to various criteria, triggers, machine learning algorithms or any combination thereof. For example, an operator request 232 to receive an adaptive navigation dataset, may include information unique to the aircraft being operated (e.g. a unique flight identification number), information about the flight management system (e.g. NDB capacity, NDB memory usage information, information regarding what type of information is currently stored in the NDB) 210, information regarding the vehicle operator 230 (e.g. operator unique identification number, operator preferences, operator health information, etc.), information regarding the passengers or cargo being carried in the aircraft, and a flight navigation plan, such that cloud services 260 can cross analyze this information with the information received from the real-time data server and vehicle history server to select navigation plan and adaptive navigation dataset 266 that will align with the preferences of the operator 230 and meet the capacity constraints of the navigation database 214. Further, cloud services 260 may transmit the navigation plan and adaptive navigation dataset 266 at certain time intervals as a consideration of the network 250 bandwidth or flight management system 210 resources.

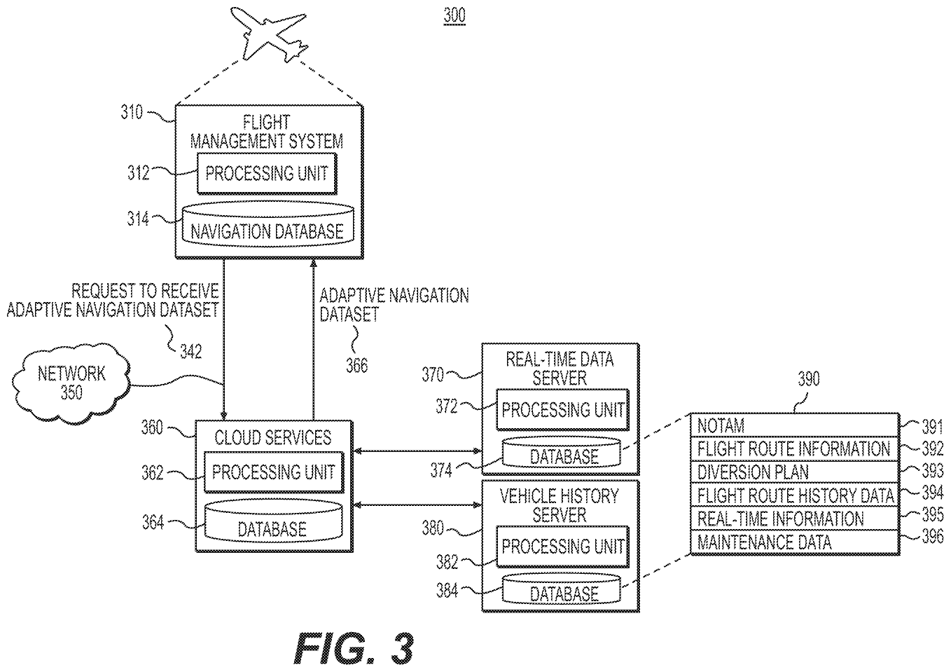

FIG. 3 illustrates an alternative flight navigation environment 300 that is similar to the flight navigation environment 200 in FIG. 2, except in FIG. 3 the flight management system 310 is in direct communication with cloud services 360. In an ideal embodiment, the flight management system 310 would transmit a request 342 to receive adaptive navigation dataset to cloud services 360. Upon receipt of the request 342 to receive an adaptive navigation dataset, cloud services 360 may obtain real-time information from a real-time data server 370 and vehicle history information from a vehicle history server 380, in order to generate and then transmit a navigation plan and an adaptive navigation dataset 366 back to the flight management system 310. Once the navigation plan and adaptive navigation dataset 366 are received at the flight management system 310, it may be stored in the flight management system navigation database 314.

The flight management system 310 may have various computing components to manipulate the received navigation plan and adaptive navigation dataset 266, such as, a processing unit 312 (e.g. a processor and modules) and a navigation database 314. The vehicle management system may be a computer, a server, a mobile device (e.g. PDA, mobile phone, or a tablet), etc. Cloud services 360 may be a server, a computer or mobile device and it may include computing components, such as a processing unit 362 (e.g. a processor and modules) and a database 364. Similarly, the real-time data server 370 may include computing components, such as a processing unit 372 (e.g. a processor and modules) and a database 374. Additionally, the vehicle history server 380 may include computing components, such as a processing unit 382 (e.g. a processor and modules) and a database 384. Both the real-time data server database 374 and the vehicle history server database 384 may store data including, but not limited to, operator notifications 391 (e.g. airline procedures, terminal information, etc.), route information 392 (e.g. runway information, route clearances, waypoints, and airport information), diversion plans 393, route history data 394, real-time information 395, and maintenance data 396. The network 350 may be the Internet, VPN, LAN, WAN, Airborne Wireless Network (AWN), a vehicle-to-vehicle network, 3G/4G/5G wireless signal, WiMax, CDMA, LTE, VHF/HF/Datalink satellite uplink or any combination thereof.

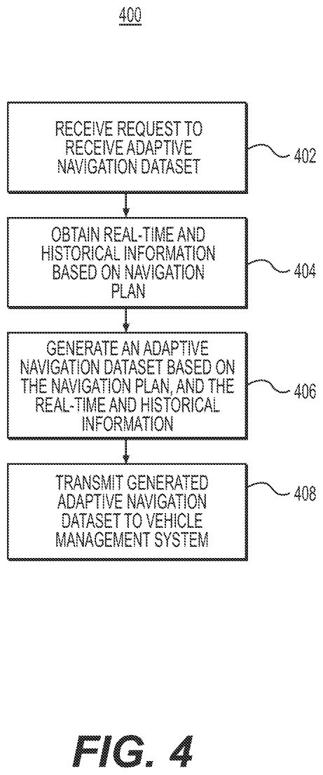

FIG. 4 depicts a flow diagram of a method 400 for processing a request to receive adaptive navigation dataset 132. Once the request to receive adaptive navigation dataset 132 is received at cloud services 160 (Step 402), cloud services 160 obtains real-time and historical information based on the navigation plan 142 sent along with the request to receive adaptive navigation dataset 132 from a real-time data server 170 and a vehicle history server 180 (Step 404). Cloud services 160 then generates a navigation plan and an adaptive navigation dataset 166, based on the navigation plan 142 and the real-time and historical information 190 (Step 406). The cloud services 160 then transmits the generated navigation plan and adaptive navigation dataset 166 to the vehicle management system 110 (Step 408).

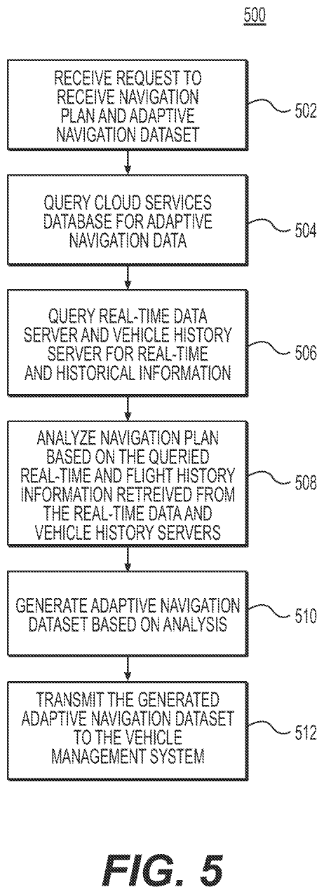

FIG. 5 depicts a flow diagram of an exemplary method 500 for processing a request to receive adaptive navigation dataset 132. Once the request to receive adaptive navigation dataset 132 is received at cloud services 160 (Step 502), cloud services 160 queries the cloud services database 164 for adaptive navigation data (Step 504). Cloud services 160 additionally queries the real-time data server 170 and vehicle history server 180 for real-time and historical information 190 (Step 506). Cloud services 160 then analyzes the navigation plan 142 based on the queried real-time and flight history information 190 retrieved from the real-time data server 170 and vehicle history server 180 (Step 508). Cloud services 160 then generates a navigation plan and adaptive navigation dataset 166, based on the analysis (Step 510). The cloud services 160 then transmits the generated navigation plan and adaptive navigation dataset 166 to the vehicle management system 110 (Step 512).

It should be understood by one having ordinary skill in the art, that in an ideal embodiment, the aforementioned steps will occur prior to the departure of a vehicle (e.g. pre-flight). However, some steps may be executed at any time while the vehicle is en route to its designated point of interest. Therefore, many steps can occur outside of the AIRAC cycle, for example, by the second, minute, hourly, daily, weekly, etc. Additionally, it will be understood that the method 400 is flexible and is merely illustrative. For example, the arrangement of steps is for illustrative purposes only and is not meant to limit the method 400 in any way; as such, it should be understood that the steps can proceed in any order and additional or intervening steps can be included without detracting from embodiments of the invention.

It should also be understood that real-time and flight history information 190 is not limited to the examples conveyed in environment 100. Additional information that may be obtained, can include, but is not limited to:

Operator Notification

NOTAM: Notice to Airmen

Runway information

Landing information

Takeoff information

Equipment in use at airport

Known hazards (lasers, rocket launches, parachute jumps)

Temporary flight restrictions

Inoperable lights on buildings and runways

Military exercises

Geographical location of hazard or obstruction

Route Information

SID (Standard Instrument Departure) instructions

STAR (Standard Terminal Arrival Route) instructions

Flight levels

Operating certificate information

Traffic advisories

Aircraft identification information

Estimated time enroute

Fuel onboard

Crew information

Total number of people onboard vehicle (e.g. aircraft, spaceship, etc.)

Mean sea level information

Route forecast information (e.g. weather information)

Payload information

Takeoff weight

Landing weight

Waypoint information

Terminal data

FMS information (e.g. navigation database memory capacity)

Navigation plan

Diversion Plan

Alternate airfield information

Equitime point information

Point of interest information

Groundspeed information

Airspeed information

Angle between point of interest and alternate airfield

Drift information

C=D*O*sec θ/2A

Route History Data

Schedule information

Vehicle connection information

Time in flight information

Airport IATA code

ICAO code

Latitude and longitude information

Real-Time Information

ACARS, Automatic Dependent Surveillance: ADS-B and ADS-C, FANS, position reporting

Required are navigation (RNAV) information

Required Navigation Performance (RNP) information

Localizer performance with vertical guidance (LPV) information

Maintenance Data

Record of maintenance for vehicle

Date maintenance was performed

Description of the type of maintenance performed

Manufacturer information

Services letters

Work order information

Troubleshooting information

Vehicle unique identifier information

Predictive maintenance analytics data

This real-time and flight history information 190 may be stored in the cloud services 160, the real-time data server 170 and/or the vehicle history server 180. The real-time and flight history information 190 and the searches/queries may be stored in a non-conventional way, such that a request to receive adaptive navigation dataset 132 that are commonly received at the cloud services 160 or request to receive adaptive navigation dataset 132 that are consistently requested from a specific operator 130 can be readily available, for example, by being stored in cloud services 160 cache (not illustrated). In this instance, machine learning algorithms may obtain real-time and flight history information 190 in advance and in anticipation of a future request to receive adaptive navigation dataset 132. By having the real-time and flight history information 190 readily available, cloud services allows the vehicle navigation environment 100 to operate more efficiently. Further, searches/queries may be grouped together based on common data points. In the example below there are four queries:

Query 1: request to receive adaptive navigation dataset for region A+Navigation Plan for route A

Result 1: Navigation Plan and Adaptive Navigation Dataset for region A+Navigation Plan for route A+Real-time Information for route A returned

Query 2: request to receive adaptive navigation dataset for region A+Navigation Plan for route B

Result 2: Navigation Plan and Adaptive Navigation Dataset for region A+Navigation Plan for route B+Real-time Information for route B returned

Query 3: request to receive adaptive navigation dataset for region C+Navigation Plan for route C

Result 3: Navigation Plan and Adaptive Navigation Dataset for route C+Navigation Plan for route C+Real-time Information for route C returned

Query 4: request to receive adaptive navigation dataset for region C+Navigation Plan for route D

Result 4: Navigation Plan and Adaptive Navigation Dataset for route C+Navigation Plan for route D+Real-time Information for route D returned

Here, all four queries are different; however, queries 1 and 2 may be grouped based on the commonality of the need for data pertaining to region A. Similarly, queries 3 and 4 may be grouped together based on the commonality of the need for data pertaining to region C. Machine learning algorithms can leverage real-time and historical data pertaining to request to receive adaptive navigation dataset 132 and the resulting searches/queries to provide relevant navigation plan and adaptive navigation dataset 166 faster and more efficiently by keeping such information stored in cache.

Additionally, searches/queries may be rewritten once a request to receive adaptive navigation dataset 132 is received at cloud services 160. Could services 160 may crowdsource navigation plan 142 information and real-time and flight history information 190, and analyze such information to assess common requests for data among an array of vehicles to determine a spike in a request for certain information, then rewrite queries to the real-time data server 170 and vehicle history server 180. For example, upon receipt of a request to receive adaptive navigation dataset 132, cloud services 160 may query the real-time data server 170 for real-time and flight history information 190. In analyzing the query from cloud services 160, the real-time data server 170 may detect a spike in queried information (e.g. a query for weather information pertaining to a particular route and point of interest) and in response, provide cloud services 160 with the result of the its initial query and a new rewritten query that cloud services 160 should use in obtaining real-time and flight history information 190 from the vehicle history server 180. Determining, whether there is a spike in searches/queries for specific information can be a function of time and a number of queries exceeding a certain threshold for a specific type of information. For example, cloud services 160, the real-time data server 170 or vehicle history server 170 may detect that over a twenty-four hour period, there have been fifty requests for real-time weather related information pertaining to routes where the ultimate destination is Chicago. If in this example, the threshold for detecting a spike in queries, is the receipt of twenty-five queries within a (potentially predetermined) twenty-four hour period, cloud services 160, the real-time data server 170 or vehicle history server 170 may rewrite queries for routes with the end destination of Chicago to ensure that real-time information regarding weather is included in the returned navigation plan and adaptive navigation dataset 166. Alternatively, queries may be rewritten as a function of the cloud services 160 detecting that certain real-time and flight history information 190 needs to be more heavily weighted. Could services 160 may crowdsource navigation plan 142 information and real-time and flight history information 190, and analyze such information to assess keywords, sounds and images, for urgent/critical information, then rewrite queries to the real-time data server 170 and vehicle history server 180. For example, cloud services 160, the real-time data server 170 or vehicle history server 170 may detect a NOTAM with keywords pertaining to an unexpected military exercise occurring in close proximity to Washington, D.C. In this example, cloud services 160 may assign instructions to its own system and the real-time data server and the vehicle history server 180 to weight information pertaining to operator notifications more heavily and rewrite queries associated with Washington, D.C. as a point of interest.

In one embodiment the transmitted navigation plan and adaptive navigation dataset 166 is generated based partially on the capacity of the vehicle management system navigation database 114. Cloud services 160 can prioritize certain data blocks in the transmission of a navigation and adaptive navigation dataset 166. Further, the vehicle management system 160, cloud services 160, real-time server 170 and vehicle history server 180 may have processors and/or modules, which provide instructions which decide what type of information is stored in cache, what type of information to store in a database and predict what of data may be queried next.

The systems, apparatuses, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures, or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware. The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

It is intended that the specification and examples be considered as exemplary only, with a true scope and spirit of the disclosure being indicated by the following claims.

What is claimed is:

1. A method for generating and providing adaptive navigation datasets to a vehicle navigation database, comprising:
receiving, at a remote server, a request to receive an adaptive navigation dataset associated with a navigation plan;
obtaining, by the remote server, real-time and historical information based on the navigation plan;
generating, by the remote server, an adaptive navigation dataset based on the navigation plan, and the obtained real-time and historical information; and
transmitting, the generated adaptive navigation dataset, from the remote server to a remote plan loader and/or the navigation database located on the vehicle.

2. The method of claim 1, wherein the request to receive adaptive navigation dataset occurs prior to the departure of a vehicle from a starting point.

3. The method of claim 1, wherein the request to receive the adaptive navigation dataset includes a navigation plan and originates from the remote plan loader associated with a vehicle and a vehicle management system; and
wherein the vehicle management system includes a navigation database located on the vehicle.

4. The method of claim 1, further comprising querying, by the remote server, a real-time data server and a vehicle history server for data specific to the point of interest and route the vehicle will traverse.

5. The method of claim 1, wherein all data transmissions are encrypted.

6. The method of claim 1, further comprising, detecting a spike in a queries for information; and
wherein, determining that there is a spike in queries for certain information, requires the number of queries for that information exceeding a threshold over a specific time period.

7. The method of claim 6, wherein the queried information is associated with information pertaining to one or more of an operator notification, route information, diversion plan, route history data, real-time information or maintenance data.

8. The method of claim 6, wherein the information that exceeds the threshold is prioritized and transmitted to the plan loader before information that did not exceed the threshold.

9. A computer system for generating and providing adaptive navigation datasets to a vehicle navigation database, comprising:
a memory having processor-readable instructions stored therein; and
a processor configured to access the memory and execute the processor-readable instructions, which when executed by the processor configures the processor to perform plurality of functions, including functions for:
receiving, at a remote server, a request to receive an adaptive navigation dataset associated with a navigation plan;
obtaining, by the remote server, real-time and historical information based on the navigation plan;
generating, by the remote server, an adaptive navigation dataset based on the navigation plan, and the obtained real-time and historical information; and
transmitting, the generated adaptive navigation dataset, from the remote server to a remote plan loader and/or the navigation database located on the vehicle.

10. The computer system of claim 9, wherein the request to receive adaptive navigation dataset occurs prior to the departure of a vehicle from a starting point.

11. The computer system of claim 9, wherein the request to receive adaptive navigation dataset includes a navigation plan and originates from the remote plan loader associated with a vehicle and a vehicle management system; and
wherein the vehicle management system includes a navigation database located on the vehicle.

12. The computer system of claim 9, further comprising, querying, by the remote server, a real-time data server and a vehicle history server for data specific to the point of interest and route the vehicle will traverse.

13. The computer system of claim 9, wherein all data transmissions are encrypted.

14. The computer system of claim 9, wherein the processor is further configured for detecting a spike in a queries for information; and
wherein, determining that there is a spike in queries for certain information, requires the number of queries for that information exceeding a threshold over a specific time period.

15. The computer system of claim 14, wherein the queried information is associated with information pertaining to one or more of an operator notification, route information, diversion plan, route history data, real-time information or maintenance data.

16. The computer system of claim 14, wherein the information that exceeds the threshold is prioritized and transmitted to the plan loader before information that did not exceed the threshold.

17. A non-transitory computer-readable medium for computer system for generating and providing adaptive navigation datasets to a vehicle navigation database, comprising:
a memory having processor-readable instructions stored therein, to direct a processor for:
receiving, at a remote server, a request to receive an adaptive navigation dataset associated with a navigation plan;
obtaining, by the remote server, real-time and historical information based on the navigation plan;
generating, by the remote server, an adaptive navigation dataset based on the navigation plan, and the obtained real-time and historical information; and
transmitting, the generated adaptive navigation dataset, from the remote server to a remote plan loader and/or the navigation database located on the vehicle.

18. The non-transitory computer-readable medium of claim 17, wherein the request to receive adaptive navigation dataset occurs prior to the departure of a vehicle from a starting point.

19. The non-transitory computer-readable medium of claim 17, wherein all data transmissions are encrypted.

20. The non-transitory computer-readable medium of claim 17, further comprising, detecting a spike in a queries for information; and
wherein, determining that there is a spike in queries for certain information, requires the number of queries for that information exceeding a threshold over a specific time period.
